(19) United States
(12) Patent Application Publication
(10) Pub. No.: US 2011/0241642 A1
(43) Pub. Date: Oct. 6, 2011

(54) VOLTAGE CONVERTER

(75) Inventor: Xiaoyu Xi, Plano, TX (US)

(73) Assignee: Monolithic Power Systems, Inc., San Jose, CA (US)

(21) Appl. No.: 13/038,596

(22) Filed: Mar. 2, 2011

Related U.S. Application Data
(60) Provisional application No. 61/309,677, filed on Mar. 2, 2010.

(51) Int. Cl. G05F 1/618

(52) U.S. Cl. 323/285

(57) ABSTRACT

A voltage converter includes an input circuit that is designed to receive an input voltage. The voltage converter includes a switch circuit comprising a pair of switches that receive the input voltage through the input circuit. The voltage converter includes an output circuit configured to supply current at a regulated voltage. The voltage converter includes a feedback circuit that generates a feedback signal. The voltage converter includes a switch control circuit that generates a switch control signal during an operational mode of circuit operation. The voltage converter includes an idle mode control circuit that generates an idle mode control signal during the operational mode and causes the switch circuit to turn off one of the switches for a period of time. The voltage converter includes a switch turn-off circuit that generates a second control signal, which causes the switch circuit to turn off the other switch.

### CROSS-REFERENCE TO RELATED APPLICATIONS

This application claims priority to U.S. Provisional Application No. 61/309,677 filed on Mar. 2, 2010 and titled “VOLTAGE CONVERTERS,” all of which is incorporated by reference in its entirety.

### TECHNICAL FIELD

This description generally relates to voltage converters.

### BACKGROUND

Switching regulators are a type of voltage converters that can be configured to operate at high efficiencies when operating in a designated range. However, the efficiency is generally a function of output current and typically decreases at low output current.

### SUMMARY

In a general aspect, a voltage converter includes an input circuit comprising an inductor that is designed to receive an input voltage. The voltage converter also includes a switch circuit connected to the input circuit. The switch circuit includes a pair of switches that receive the input voltage through the input circuit. The voltage converter includes an output circuit connected to the switch circuit. The output circuit comprises an output terminal and an output capacitor that are configured to supply current at a regulated voltage. The voltage converter also includes a feedback circuit. The feedback circuit is designed to monitor a signal from the output terminal in order to generate a feedback signal. The voltage converter includes a switch control circuit connected to the feedback circuit that generates a switch control signal. The switch control signal is generated during an operational mode of circuit operation, the switch control signal being responsive to the feedback signal to vary a duty cycle of the switches to maintain the output terminal at the regulated voltage. The voltage converter further includes an idle mode control circuit connected to the feedback circuit and the switch circuit. The idle mode control circuit generates an idle mode control signal during the operational mode of circuit operation to indicate an entry into an idle mode and cause the switch circuit to turn off one of the switches for a period of time when an output signal from the feedback circuit falls below a pre-determined threshold level. In addition, the voltage converter includes a switch turn-off circuit connected to the switch circuit that generates a second control signal. The second control signal causes the switch circuit to turn off the other switch when the current flowing through the inductor reverses a direction of flow. During the idle mode, both switches remain off and the current flowing through the inductor decays to zero.

Particular implementations may include one or more of the following features. The idle mode control signal and the second control signal can be distinct signals. The idle mode control signal and the second control signal can be applied to the switch circuit at different times. The idle mode control signal and the second control signal can be generated independent of a load.

Particular configurations may be utilized to realize one or more features. The boost voltage converter described in this specification can include a pair of switches that are referred to as the high side switch and the low side switch. The voltage converter can operate in pulse width modulator (PWM) mode when active, or perform no switching when idle.

In PWM mode, the high side switch and low side switch are always alternatively on (i.e., when one is off the other is on). Thus, when the low side switch remains off for a sustained long period of time, for example due to unexpected overshoot of output or sudden decrease of input reference, then the high side switch, which is on during that time, could cause the inductor current to go up to an excessively high level in the negative direction (negative here meaning current flow backward from output to input). A negative current may be acceptable for the PWM mode of operation, but such excessively high current can result in device or component damage.

To protect the switches from damage, a separate POFF control signal is provided as a negative current limit protection for the high side switch. When the negative current of the high side switch reaches a predetermined level, the circuit turns the switch off to prevent a fault condition from happening. This negative current limit is always active during the PWM mode for protection purpose.

The general and specific aspects can be implemented using a circuit, a method, a system, or any combination of circuits, systems and methods. The details of one or more implementations are set forth in the accompanying drawings and the description below. Other features, aspects, and advantages will be apparent from the description, the drawings, and the claims.

The above and other aspects will now be described in detail with reference to the following drawings.

### DESCRIPTION OF DRAWINGS

FIG. 1 illustrates a block diagram showing an example of a voltage converter.

FIGS. 2a, 2b, and 2c illustrate an example of a process for regulating voltage.

FIG. 3 illustrates example signal traces during various circuit operations.

FIG. 4 illustrates a block diagram showing a second example of a voltage converter.

### DETAILED DESCRIPTION

Voltage converters (also referred to as voltage regulators) may be configured to enter an idle state to conserve power. For example, switching regulators are voltage converters that can enter an idle state to conserve power. A boost idle converter design can be used to implement the voltage conversion and such a design can enter an idle state where one or more switches in the voltage converter are not switching.

In voltage regulators, reverse current that flows when the regulators are in idle state can be problematic and damage devices. Techniques, systems and apparatus are described for controlling voltage conversion in a way that reduces the reverse current when the device is placed in idle mode. In some implementations, a boost idle converter may be implemented to include two switches (for example, a high side switch and a low side switch) that operate strictly in PWM mode when active, and perform no switching when idle. In such an implementation the reverse current decays to zero when the switches are turned off when the converter is idle.

For example, in one implementation, in the PWM mode, the high side switch and low side switch are always alternatively on (i.e., when one is off the other is on). Thus, when the low side switch remains off for a sustained long period of time, for example due to unexpected overshoot of output, or sudden decrease of input reference, then the high side switch, which is on during that time, could cause the inductor current to go up to an excessively high level in the negative direction (negative here meaning current flow backward from output to input). A negative current may be acceptable for the PWM mode of operation, but such excessively high current may result in device or component damage.

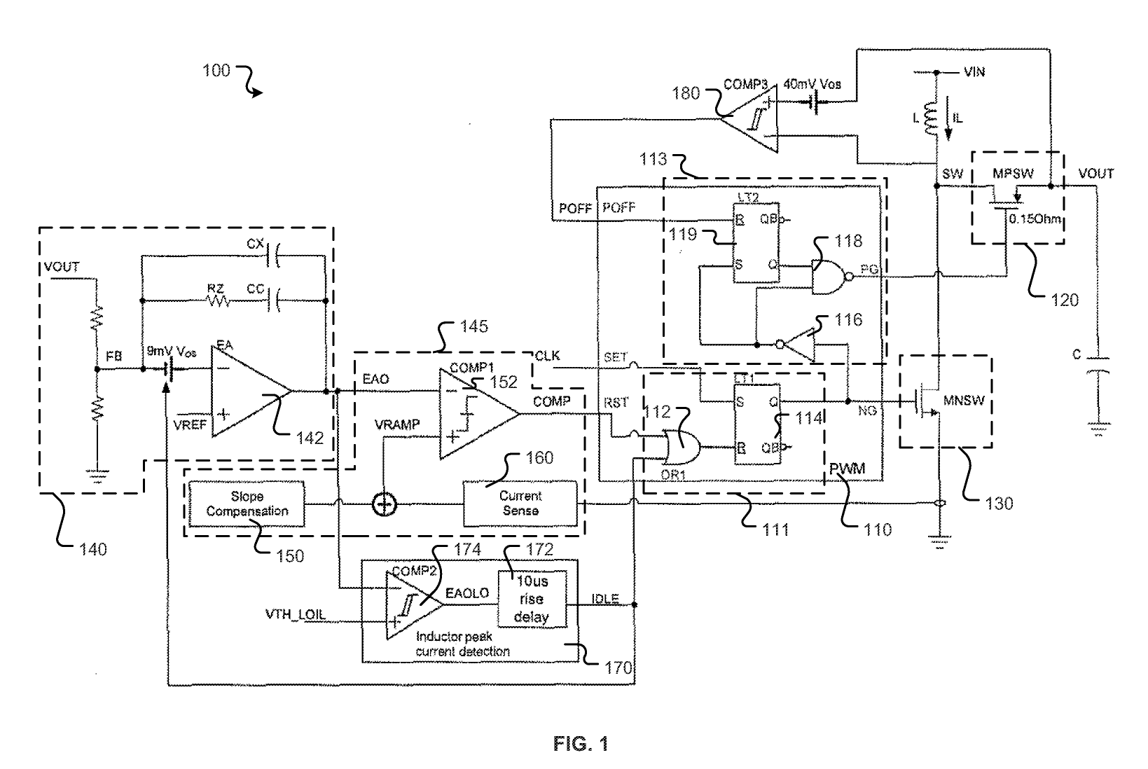

To protect the switches from damage, a separate POFF control signal is provided as a negative current limit protection for the high side switch. When the negative current of the high side switch reaches a predetermined level (for example, detected by COMP3 comparator by comparing V_{OUT} and SW node with a given threshold, as described with reference to FIG. 1 below), the circuit turns the switch off to prevent a fault condition from happening. This negative current limit may be configured to be always active during the PWM mode for protection purpose.

When the boost voltage converter changes its operation from the PWM mode to the idle mode, the low side switch is turned off. The low side switch can remain off for a varying length of period, and thus the above mentioned scenario can occur during this mode transition. The POFF signal turns off the high side switch after its current reaches the negative limit. Turning off the high side switch completes the entry into the idle mode. The PWM operation will resume only after the low side switch is turned back on again, which means the boost converter has exited the idle mode.

FIG. 1 illustrates a block diagram showing an example of a voltage converter. The voltage converter 100 can enter an idle mode to reduce power consumption. When not in the idle mode, the voltage converter 100 regulates an output voltage in an operational mode by switching a pair of switches 120 and 130. The voltage converter 100 includes a pulse width modulator (PWM) 110 that drives the pair of switches 120 and 130. The switches 120 and 130 can be implemented using transistors, such as P-type or N-type metal-oxide-semiconductor field-effect transistor (MOSFET). In the example shown in FIG. 1, the switches 120 and 130 are implemented as P-type MOSFET (PMOS) 120 and N-type MOSFET (NMOS) 130. However, other combinations of PMOS and/or NMOS can be used. Control signals are applied to the PWM 110 to trigger the PWM 110 to turn on/off the two switches 120 and 130.

The voltage converter 100 includes circuitry to provide error amplifier compensation 140; peak inductor current detection (to indicate entry into idle mode and to turn off one of the switches) 170; switch control signal generation (to trigger switching of the switches) 145; voltage regulation (by driving the switches in response to the generated switch control signal) 110 and turn off the other switch when entering the idle mode 180.

An error amplifier compensation circuit 140 is electrically connected to a switch control signal generation circuit 145 and a peak inductor current detection circuit 170. The peak inductor current detection circuit 170 is also electrically connected to one of the switches (e.g., switch 130). The PWM 110 is electrically connected to the peak inductor current detection circuit 170 and the switch control signal generation circuit 145. In addition, the PWM 110 is electrically connected to the two switches 120 and 130 and a switch-turn-off control circuit 180.

An output of the error amplifier compensation circuit 140 (EAO) is used by the switch control signal generation circuit 145 to generate a switch control signal (COMP) that triggers the PWM 110 to drive the two switches 120 and 130 during the operational mode of the voltage converter 100. An output of the peak inductor current generation circuit 170 (IDLE) is used to determine whether the voltage converter 100 should enter or exit the idle mode. The idle mode control signal, IDLE, is also used to turn off one of the two switches (e.g., switch 130) when entering the idle mode. The switch-turn-off control circuit 180 generates another control signal (POFF) that triggers the PWM 110 to turn off the other switch (e.g., switch 120) when entering the idle mode. Thus, two distinct control signals, IDLE and POFF, are generated and applied to the PWM to turn off the two switches 120 and 130. These two distinct control signals, IDLE and POFF, enable independent control over the two switches 120 and 130 when entering the idle mode. Also, IDLE and POFF can be applied at different times or at the same time based on different applications of the voltage converter 100.

Based on the peak inductor current detection, the idle mode control signal IDLE is generated and used to determine whether the voltage converter 100 enters or exits the idle mode. A feedback signal (FB) from an output voltage (VOUT) is applied as an input to an error amplifier 142. A reference voltage (VREF) is applied as the other input to the error amplifier 142. Also, a peak inductor current detection component 170 is electrically connected to the PWM 110 and the error amplifier 142. The peak inductor current detection component 170 includes a comparator (COMP2) that compares two input signals and output the idle mode control signal, IDLE. The two input signals applied to COMP2 includes an output signal of the error amplifier, EAO, and a threshold voltage, VTH_LOIL.

When EAO is detected to be lower than VTH_LOIL, this indicates that a peak inductor current is lower than a pre-determined threshold. In response to EAO being lower than VTH_LOIL, the output signal IDLE is set to high (e.g., the value “1” in binary) and the voltage converter 100 enters the idle mode where the switching of the switches 120 and 130 is suspended. During the idle mode, power consumption of the voltage converter is minimized.

When IDLE is set to “1”0 to indicate entry into the idle mode, the signal is applied to the PWM 110 to turn off one of the switches (e.g., switch 130). When IDLE (set to “1”) triggers the PWM 110 to turn off the switch 130, the other switch 120 remains on to allow the inductor current IL to flow through switch 120. When switch 120 is on and switch 130 is off, the output voltage VOUT is higher than the input voltage VIN. Eventually, the inductor current IL reverses, which sets the POFF output signal of comparator COMP3 of the switch-turn off circuit 180 to “1”. The POFF signal set to “1” triggers the PWM to turn off switch 120. At this point, both switches 120 and 130 are off and the voltage converter enters the idle mode to conserve power consumption. During the idle mode, no energy is transferred to the output and a load is allowed to discharge the output.

The IDLE signal also adds an input offset to the error amplifier 142, so that VOUT needs to drift lower than VREF (regulated level in PWM mode) by a pre-determined amount before EAO can rise back above the threshold VTH_LOIL to exit the IDLE mode. This allows accurate control of output ripple during the IDLE mode. VOUT may be maintained within this hysteresis window, which is determined exactly by the added offset.

When the output voltage VOUT drifts below VREF by a predetermined threshold level, the voltage converter is re-energized to bring the output back up to a nominal operating level. In particular, whenever EAO rises above VTH_LOIL, IDLE is reset to “0” to exit the idle mode, and the voltage converter may immediately resume switching the switches 120 and 130 to deliver power to the output.

To enable the operational mode (IDLE=0) of the switching transistors 120 and 130, the output signal EAO of the error amplifier circuit is provided as an input to a comparator COMP1. The other input signal, VRAMP, applied to COMP1 is obtained by summing an output from a slope compensation component 150 together with an output from a current sense component 160. The current sense component 160 senses or detects a current flowing through switch 130. In the example shown in FIG. 1, the current sense component 160 senses or detects a source current from the NMOS transistor 130.

COMP1 compares EAO to VRAMP to generate the output signal COMP. The generated output signal COMP is applied to the PWM 110 as a control signal to selectively switch the switches 120 and 130. EAO is an envelop signal of VRAMP, which is proportional to a peak inductor current level. When COMP1 determines that VRAMP is at a level higher than EAO, COMP1 sets output signal COMP to high (or “1” in binary) to trigger the PWM 110 to drive the two switches 120 and 130 during the operational mode (IDLE=0).

The PWM 110 includes a driving circuit to drive each switch. A driving circuit 111 is used to drive the NMOS transistor 130, and another driving circuit 113 is used to drive the PMOS transistor 120. The driving circuit 111 includes an OR gate (OR1) 112 and a latch (LT1) 114. The driving circuit 113 includes a NOT gate (also referred to as an inverter) 116, a NAND gate 118, and a latch (LT2) 119.

When IDLE is set to “0”, a rising edge of a clock signal CLK sets the latch 114 of the PWM 110 to turn on the NMOS switch 130. Also, an output signal of the latch 114 is sent to the NOT gate 116 to generate an inverted signal that sets the other latch 119. The inverted signal and an output of LT2 are applied to the NAND gate 118 to generate a driving signal that turns off the PMOS transistor 120.

The S input of the latch LT2 is LOW active. When the signal NG is high, this high signal sets LT2 but the PG signal does not get passed until NG goes low because of the NAND 118 gate after LT2. When POFF resets LT2, its output will remain “0” until low side switch is turned back on.

When the inductor current IL ramps up causing VRAMP to rise to a level higher than EAO, the COMP signal is set to “1” to turn off the NMOS switch 130 and turn on the PMOS switch 120. The PMOS transistor 120 remains on until the next clock rise edge turns off the PMOS transistor 120 and turns on the NMOS transistor 130 to start a next switching cycle.

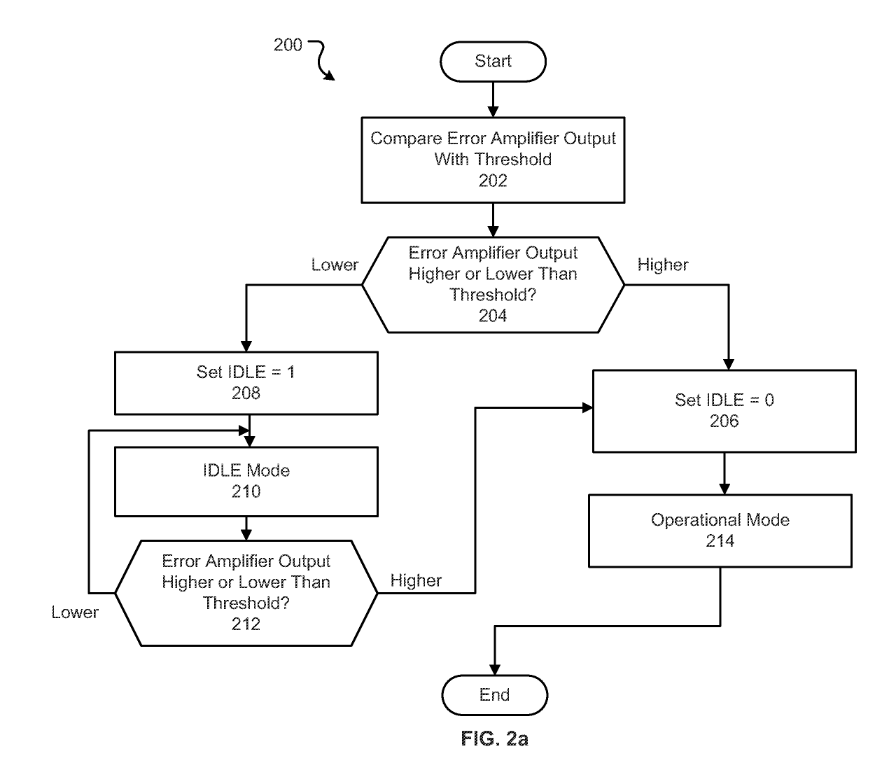

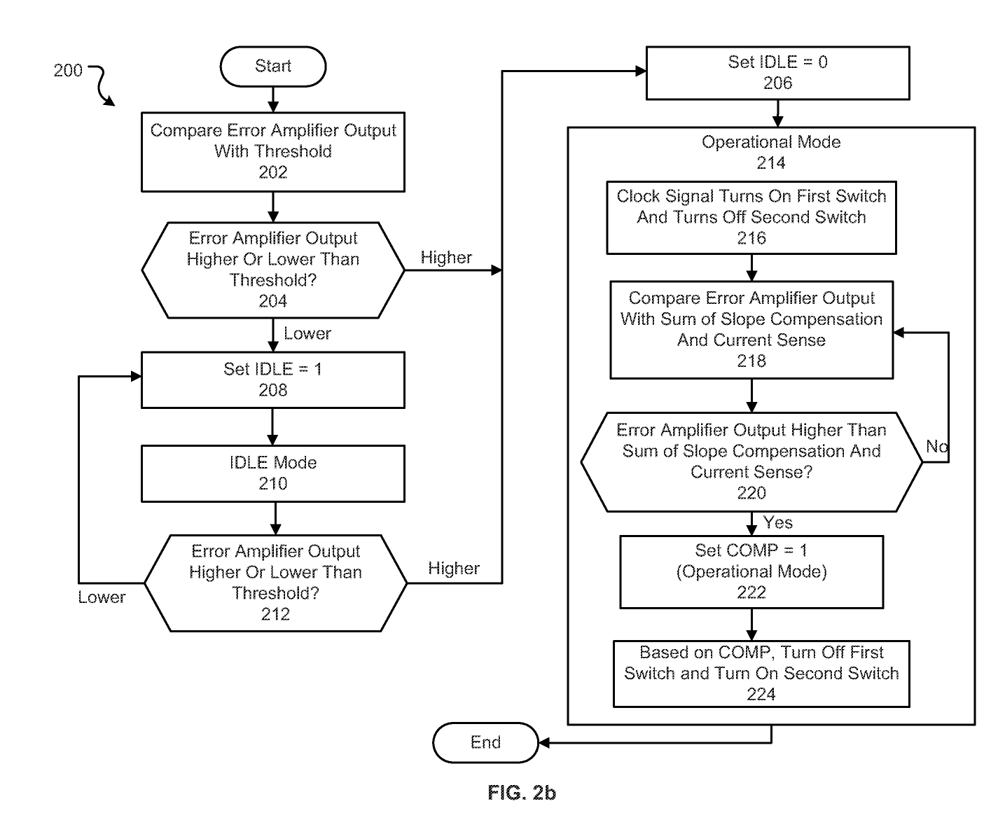

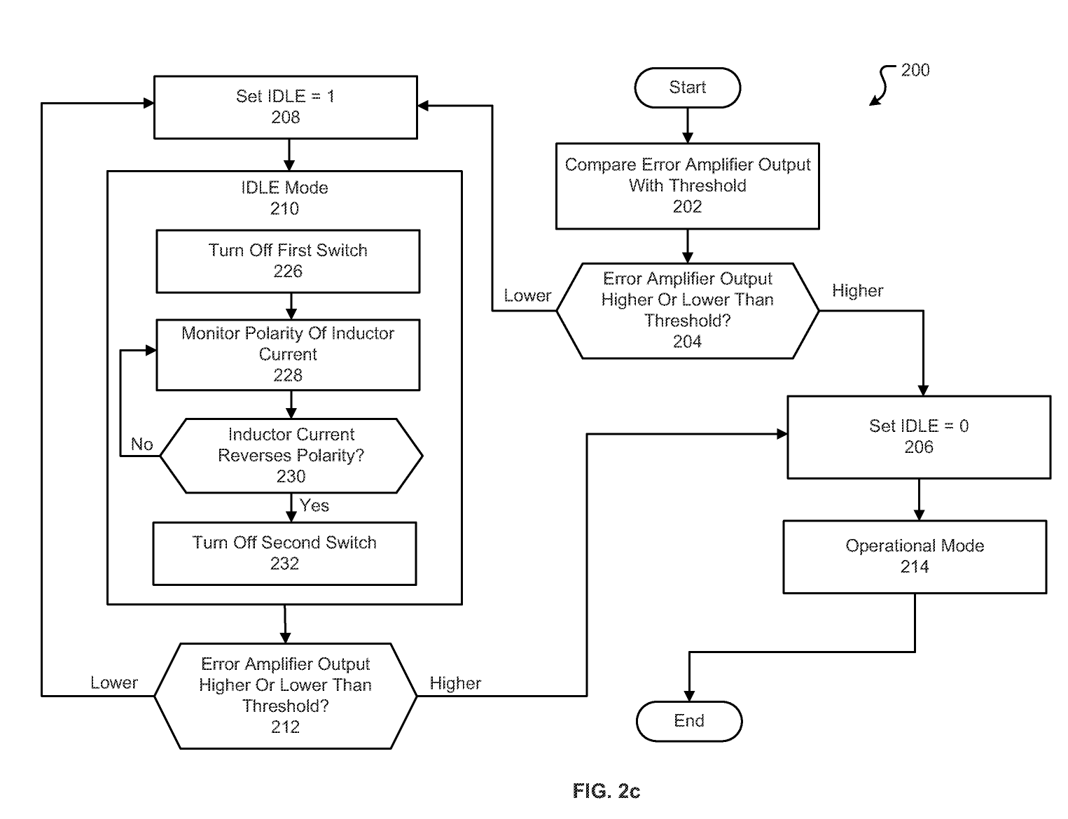

FIGS. 2a, 2b, and 2c illustrate an example of a process for regulating voltage. In the example process 200 shown in FIG. 2a, a voltage converter (e.g., voltage converter 100) monitors an error amplifier output (e.g., EAO) by comparing the error amplifier output with a threshold level (e.g., VTH_LOIL) (202). Based on the monitoring, the voltage converter determines whether the error amplifier output is higher or lower than the threshold level (204). When the voltage converter detects that the error amplifier output is higher than the threshold, the idle mode control signal (e.g., IDLE) is set to “0” (206) to trigger the voltage converter to operate in the operational mode (214). When the voltage converter detects that the error amplifier output is lower than the threshold, the idle mode control signal is set to “1” (208) to trigger the voltage converter to enter into the idle mode (210).

During the idle mode, the voltage converter continuously monitors the error amplifier output and determines whether the error amplifier output rises back higher than the threshold (212). In the idle mode, a feedback voltage (e.g., VFB) needs to drift below a reference voltage (e.g., VREF) by a predetermined threshold value (e.g., ΔV) before the error amplifier output rises above the threshold level. When the voltage converter detects that the error amplifier output rises above the threshold level, the idle mode control signal is set to “0” (206). The voltage converter is re-energized to bring the output back up and exit the idle mode. The voltage converter then operates in the operational mode (214).

FIG. 2b illustrates an example process 200 for operating switches in an operational mode. In the operational mode (214), the voltage converter (e.g., the voltage converter 100 described with reference to FIG. 1) uses a rising edge of a clock signal to turn on a first switch (e.g., switch 130) and turn off a second switch (e.g., switch 120) (216). The voltage converter compares the error amplifier output with a sum of two outputs (218). For example, the signal VRAMP in FIG. 1 represents a sum of a slope compensated output and a current sense output. As described above with respect to FIG. 1, the current sense output can be associated with a current detected from switch 130. The voltage converter determines whether the error amplifier output is higher than VRAMP (220). When the voltage converter detects that the error amplifier output is higher than VRAMP, a switch control signal (COMP) is set to “1” (222). The COMP signal set to “1” is used by a PWM (for example, PWM 110 in FIG. 1) to switch the switches 120 and 130 (224). For example, the PWM 110 turns off switch 130 and turns on switch 120, as described earlier with respect to FIG. 1. The voltage converter continues to operate in the operational mode until IDLE is set to “1”0 again.

FIG. 2c shows an example process 200 for turning off switches when a voltage converter enters an idle mode. When an idle mode control signal (e.g., IDLE) is set to “1”, the voltage converter (e.g., voltage converter 100 described with reference to FIG. 1) is triggered to enter the idle mode. The IDLE signal set to “1” triggers the PWM to turn off a first switch (e.g., switch 130) (226). The voltage converter monitors a polarity of an inductor current (228) to determine whether the inductor current reverses its polarity (230). When the voltage converter detects that the inductor current reverses its polarity, a second switch that remains on (e.g., switch 120) is turned off (232). At this point, both switches are turned off and the voltage converter is in the idle mode. As described with respect to FIG. 1 above, a separate and distinct control signal, POFF, is used to turn off the second switch.

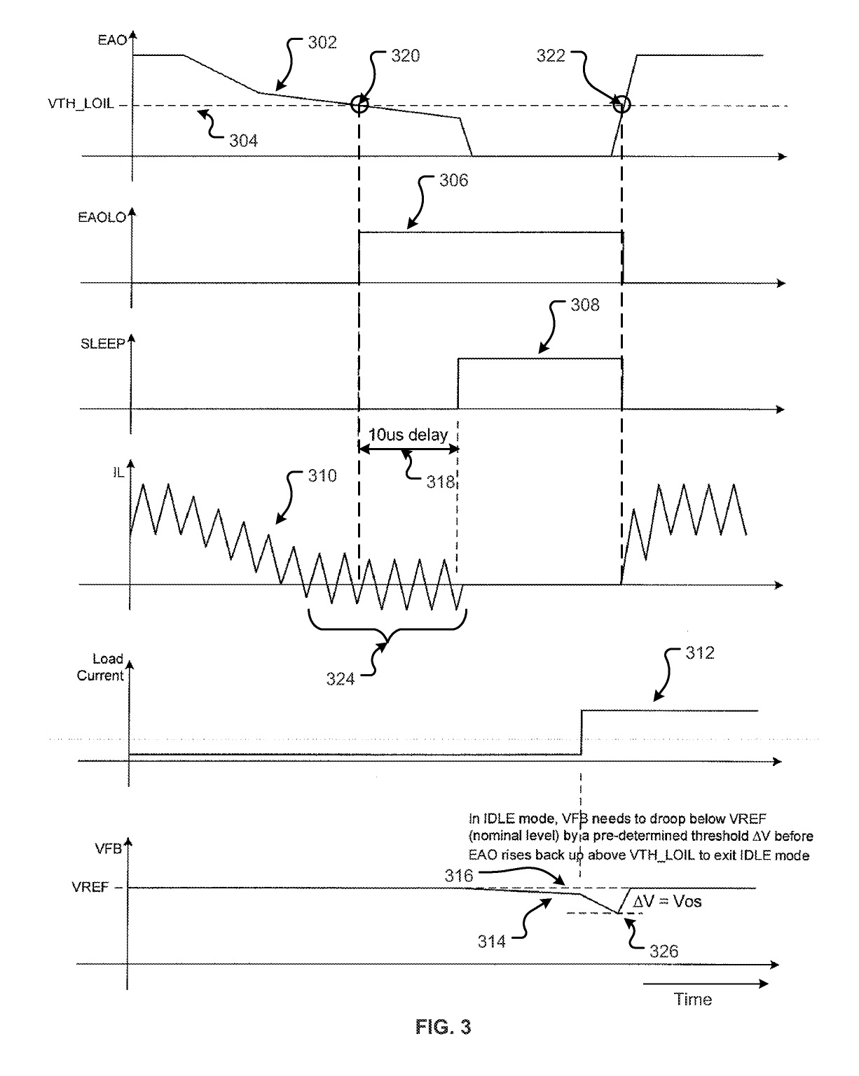

FIG. 3 illustrates example signal traces during various circuit operations. The example signal traces may be, for example, due to the various signals associated with the voltage converter 100 described with reference to FIG. 1 as they change over time. For example, the X-axis represents time. The Y-axes represent an error amplifier output signal (EAO) 302, a threshold voltage level (VTH_LOIL) 304, an output signal from COMP2 (EAOLO) 306, an idle mode control signal (IDLE or SLEEP) 308, an inductor current (IL) 310, a load current 312, a feedback voltage (VFB) 314 and a reference voltage (VREF) 316, respectively, in the traces starting from the top.

In the 1^{st} trace from the top, EAO 302 starts higher than VTH_LOIL 304 and the voltage converter operates in the operational mode. EAOLO 306 and IDLE 308 are set to low (or “0”). IL 310, which is the current flowing from VIN to VOUT, stays positive. IL is a ripple with hysteresis control and can be regulated through a hysteresis window. The load current 312 stays at a low level and VFB 314 is at a level similar to VREF 316.

When EAO 302 crosses below (320) VTH_LOIL 304, EAOLO 306 is set to “1” or “high”, and after EAOLO 306 stays at “1” for a predetermined time period 318 (e.g., 10 82 sec), IDLE 308 is also set to “1” to indicate entry into the idle mode. In addition, as EAO 302 approaches and drifts below VTH_LOIL 304, IL 310 is allowed to dip below zero. Thus, IL 310 experiences polarity reversal until the IDLE mode is entered. When the voltage converter enters the idle mode, IL 310 is at “0” and thus no current flows through the inductor.

The voltage converter is in the idle mode when both switches 120 and 130 are off. When the two switches are turned off, the SW node (see FIG. 1) has only one conduction path, which is from SW to VOUT through the body diode of switch 120. The remaining inductor current flows in this direction and decay to zero shortly. Thus, in IDLE mode, IL 310 is zero and SW node is held at the VIN level. In addition, during the IDLE mode, no energy is transferred to the output thus the load (e.g., a capacitor) discharges the output.

While in the idle mode, a change in EAO 302 to a level above VTH_LOIL 304 (322) sets IDLE to zero to indicate exit from the idle mode. The voltage converter is re-energized to allow switching of the switches. Before EAO 302 can rise above VTH_LOIL 304, VFB needs to drift below VREF for a predetermined threshold amount ΔV 326. Whenever EAO 302 rises above VTH_LOIL 304, IDLE 308 is reset to zero so that the voltage converter can immediately resume switching to deliver power to the output. Because entry and exit from the idle mode is independent of the load, the operation of the voltage converter is independent of the load (output) current.

In some implementations, one control signal (e.g., the idle mode control signal (IDLE)) is used to trigger the PWM to turn off one of the switches (e.g., switch 130), and two control signals (IDLE and POFF) are used to turn off the other switch (e.g., switch 120). For example, when IDLE is set to “1”, switch 130 is turned off. When IDLE and POFF are set to “1”, switch 120 is turned off. In addition, the POFF signal is applied after the IDLE signal because POFF is set to “1” only when IL reverses its polarity.

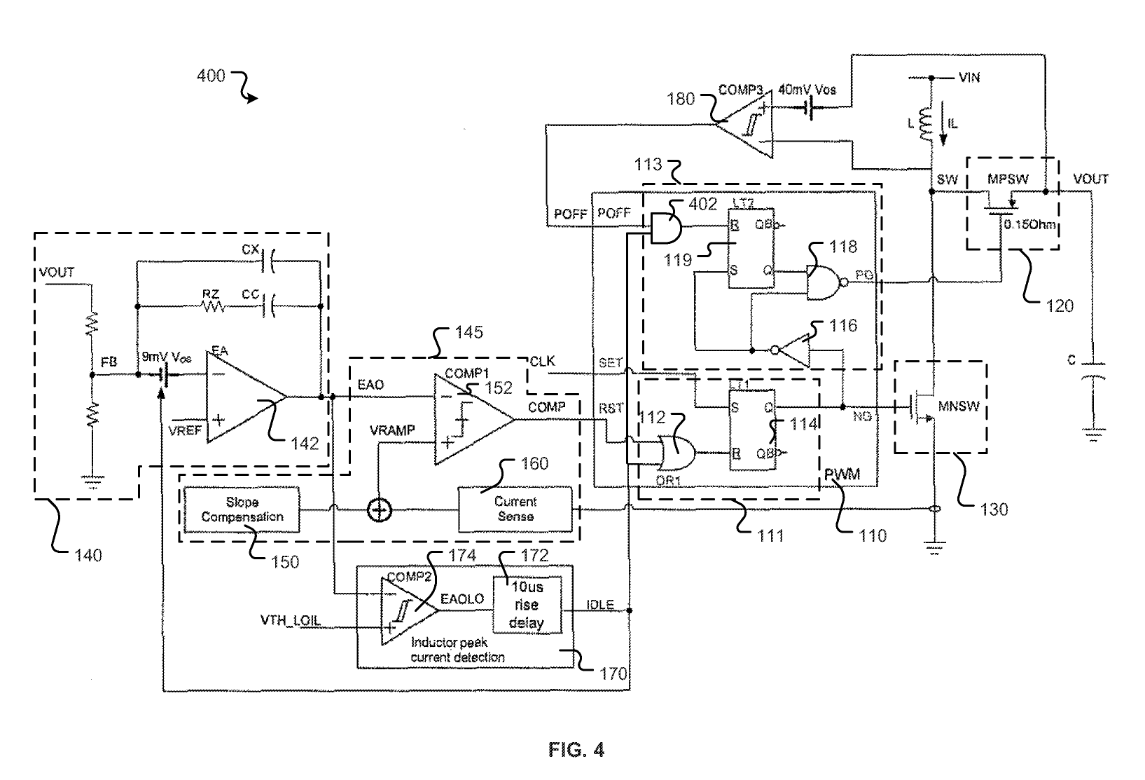

FIG. 4 illustrates a block diagram showing a second example of a voltage converter. In the voltage converter 400 shown in FIG. 4, IDLE is applied to OR1 112 to RESET LT1 114 and to turn off switch 130. In addition, IDLE and POFF are applied to a AND gate 402 to RESET LT2 119 and to turn off switch 120. Because the control signal to RESET LT2 is based on an AND operation of IDLE and POFF, the control signal to turn off switch 120 is delayed after the application of IDLE.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the described embodiments. Accordingly, other embodiments are within the scope of the following claims.

What is claimed is:

1. A voltage converter comprising:
an input circuit comprising an inductor configured to receive an input voltage;
a switch circuit connected to the input circuit, wherein the switch circuit comprises a pair of switches configured to receive the input voltage through the input circuit;
an output circuit connected to the switch circuit, wherein the output circuit comprises an output terminal and an output capacitor configured to supply current at a regulated voltage;
a feedback circuit for monitoring a signal from the output terminal to generate a feedback signal;
a switch control circuit connected to the feedback circuit configured to generate a switch control signal during an operational mode of circuit operation, the switch control signal being responsive to the feedback signal to vary a duty cycle of the pair of switches to maintain the output terminal at the regulated voltage;
an idle mode control circuit connected to the feedback circuit and the switch circuit, wherein the idle mode control circuit is configured to generate an idle mode control signal during the operational mode of circuit operation to indicate an entry into an idle mode and cause the switch circuit to turn off one of the pair of switches for a period of time when an output signal from the feedback circuit falls below a threshold level; and
a switch turn-off circuit connected to the switch circuit configured to generate a second control signal to cause the switch circuit to turn off the other switch of the pair of switches when current flowing through the inductor reverses a direction of flow.

2. The voltage converter of claim 1, wherein the idle mode control signal and the second control signal are distinct signals.

3. The voltage converter of claim 1, wherein the idle mode control signal and the second control signal enable independent control over the pair of switches.

4. The voltage converter of claim 1, wherein the idle mode control signal and the second control signal are applied to the switch circuit at different times.

5. The voltage converter of claim 1, wherein during the idle mode, both of the pair of switches remains off and the current flowing through the inductor decays to zero.

6. The voltage converter of claim 1, wherein the pair of switches includes a P-type metal-oxide-semiconductor field-effect transistor (MOSFET) switch (PMOS) and an N-type MOSFET switch (NMOS).

7. The voltage converter of claim 1, wherein the voltage converter exits the idle mode and enters the operational mode when the output signal from the feedback circuit drops below a reference voltage by a pre-determined threshold during the idle mode of circuit operation.

8. A method for controlling a voltage converter, the method comprising:
comparing, using the voltage converter, an amplifier output signal to a pre-determined threshold value;
based on the comparison, determining whether the amplifier output signal is higher or lower than the pre-determined threshold value;
based on a determination that the amplifier output signal is higher than the pre-determined threshold value, setting a first value for an idle mode control signal such that the voltage converter is enabled to operate in an operational mode;
based on a determination that the amplifier output signal is lower than the pre-determined threshold value, setting a second value for the idle mode control signal such that the voltage converter is enabled to operate in an idle mode;
when operating in the idle mode, monitoring, using the voltage converter, the amplifier output signal;
based on the monitoring when operating in the idle mode, determining whether the amplifier output signal is higher or lower than the pre-determined threshold value; and
based on a determination that the amplifier output signal is higher than the pre-determined threshold value when operating in the idle mode, setting the first value for the idle mode control signal such that the voltage converter is enabled to operate in the operational mode.

9. The method of claim 8, wherein when operating in the operational mode, the method further comprising:
turning on, using the voltage converter and based on a rising edge of a clock signal, a first switch;
turning off, using the voltage converter and based on the rising edge of the clock signal, a second switch;
comparing, using the voltage converter, the amplifier output signal with a reference sum signal;
based on the comparison, determining, using the voltage converter, whether the amplifier output signal is higher or lower than the reference sum signal;
based on a determination that the amplifier output signal is higher than the reference sum signal, setting a switch control signal to a first value by the voltage converter; and
in response to setting the switch control signal to the first value, using the voltage converter to turn off the first switch and turn on the second switch.

10. The method of claim 8, wherein when operating in the idle mode, the method further comprising:
turning off, using a first signal generated by the voltage converter, a first switch;
monitoring, using the voltage converter, a polarity of an inductor current;
determining, based on the monitoring, a time when the inductor current reverses polarity; and
based on the determination of the time when the inductor current reverses polarity, using a second signal generated by the voltage converter to turn off a second switch.

11. The method of claim 8, wherein when operating in the idle mode the amplifier output signal is set to a value that is higher than the pre-determined threshold value when a feedback voltage decreases to a value that is lower than a reference voltage by a second pre-determined threshold value.

12. The method of claim 9, wherein the reference sum signal is a sum of a slope compensated output signal and a current sense output signal.

13. The method of claim 10, wherein the second signal is distinct from the first signal.

14. The voltage converter of claim 1, wherein the idle mode control signal and the second control signal cause the switch circuit to turn off the other of the pair of switches when a current flowing through the inductor reverses a direction of flow.

15. The method of claim 10, wherein the first signal and the second signal are used to turn off the second switch, the second signal being distinct from the first signal.
